(19) United States
(12) Patent Application Publication
(10) Pub. No.: US 2012/0215749 A1
(43) Pub. Date: Aug. 23, 2012

(54) System And Method For Managing Records Using Information Governance Policies

(76) Inventors: Pierre Van Beneden, Avully (CH); Bassam Zarkout, Ottawa (CA); Serge Quiniou, Douvaine (FR); Hughes Cazeaux, Beaumont (FR)

(21) Appl. No.: 13/369,290

(22) Filed: Feb. 8, 2012

Related U.S. Application Data
(60) Provisional application No. 61/440,705, filed on Feb. 8, 2011.

(51) Int. Cl. G06F 17/30

(52) U.S. Cl. 707/694; 707/E17.009

(57) ABSTRACT

An invention for creating and managing, within an Information Governance framework, a Master Classification of Record Classes (MC-RC) and associated file plans within an entity and across jurisdictions where its sub-entities operate. The file plans are used to organize the records of the entity and apply governance rules to them, for example, retention and disposition. The invention may use two integrated modules.

The first is an Information Governance Policy Module (IGPM) which may be used to create a MC-RC for the entity and corresponding governance rules for each of the Record Classes.

The second is an Information Governance Control Module (IGCM) which allows administrators in the sub-entities to create and manage file plans using the Record Class definitions in the IGPM, associate these file plans with jurisdictions, and manage the sub-entity's records within them.

### CROSS-REFERENCE TO RELATED APPLICATION

This application claims the benefit of priority to U.S. provisional patent application Ser. No. 61/440,705, filed on Feb. 8, 2011.

### FIELD OF THE INVENTION

The present invention relates to an Information Governance (IG) technology platform designed to manage the lifecycle of information and records. The invention may be particularly suited for managing information and records based on requirements that may be (i) mandated by laws and regulations in different jurisdictions, (ii) defined by internal business requirements, (iii) defined by industry best practices, and/or (iv) defined by the internal policies of an entity.

### BACKGROUND OF THE INVENTION

The prior art lacks an efficient system for an entity to create a unified Master Classification covering Record Class definitions and governance policies. The Master Classification is a list of Record Classes, and the Record Classes may be of unique record types (e.g., invoice, statement, purchase order, etc.) organized in a hierarchy, often of a functional nature.

The prior art also lacks an efficient system to define multithreaded and multi-jurisdictional governance policies and rules that reflect the various facets of record lifecycle management and their multi-jurisdictional variations for the Record Classes of that Master Classification composite.

In such a composite, rules for one record may include (but are not limited to): 1) how long to retain records within the custody of the entity; 2) how to dispose of the records; 3) how long to retain certain metadata of records; 4) how to dispose of the metadata; 5) how long to keep records on specific storage devices and record repositories; and 6) when to move the records to other storage devices and record repositories. An entity may require multithreaded application and enforcement of the rule actions for one record such that application and enforcement are done independently of other rules for that record.

An entity seeking to manage its records in complex, multi-jurisdictional environments must rely on a highly manual and lengthy processes. These collaborative processes include manually creating and managing file plans in multiple jurisdictions, and actively managing the record life cycles within these file plans. These collaborative processes are highly manual and lengthy because they involve and require geographically and functionally dispersed parties. The parties must collaborate by, conducting meetings, exchanging e-mail, and maintaining spreadsheets. As the number of jurisdictions and the size of the entity increase, the limitations of the prior art grow significantly such that these manual processes become unmanageable. Further exacerbating this problem are the continuous changes in legal, regulatory and business requirements, and the need to adjust and expand the scope of the composite and multithreaded policies to address these changing requirements.

The prior art policy development software applications focus only on record retention and disposition policies in a single jurisdiction. Entities seeking to manage their records in complex and multijurisdictional environments may need to limit their IG programs to a single, main operating jurisdiction and to only retention and disposition policies. Such limitations may result in some aspects of IG other than retention and disposition, and other jurisdictions, to remain outside the scope of governance programs.

Prior inventions have sought to tackle these problems, but they take inefficient approaches and lack a holistic method providing a complete solution.

U.S. Pat. No. 7,233,959 “Life-cycle management engine” is one of the earlier examples of Prior Art. The patent claimed a method for managing electronic records by receiving a record identifier across a network and filing the identifier within a file plan node. Each file plan node would then, through transmission of its associated retention rule, determine the lifecycle state of the record and transmit lifecycle instructions across the network. Here, the prior art implements a static top-down file plan, a single jurisdiction, and a governance policy focused on retention and disposition.

U.S. patent application Ser. No. 12/892,658 “Method & Apparatus for Policy Distribution”, for example, enables policies to be pushed out to an enterprise. It is described as a computer apparatus and computer-implemented method for policy distribution providing a Records Management System (RMS) that is configured for setting up and maintaining local record classification and disposition policies. In this implementation, the policy is focused narrowly on retention and disposition rules, and for a single jurisdiction. In addition, the application does not provide the lifecycle management processes themselves and relies instead on external RMS products to perform that function.

With the advent of cross-jurisdictional restrictions on the storage of data, the multi-jurisdictional data privacy, retention and destruction rules and the exponential growth in records created and stored leading to increasing numbers of differing data repositories, such a lifecycle management tool does not exist.

### SUMMARY OF THE INVENTION

The invention may be embodied as an integrated computer-based system for managing records having one or more microprocessors, a record repository, and a communications network. In one embodiment, the microprocessors are programmed to execute instructions of a policy module. The policy module is configured to receive a plurality of management inputs and produce a governance policy for a record class using the management inputs. The governance policy may include a description of the management inputs and/or identify jurisdictions for which the policy is applicable. The governance policy may also identify a business even that triggers application of the governance policy. In one embodiment, at least one of the governance policies identifies a duration after which the policy is applied. The policies may also identify at least one action that is triggered after the occurrence of an event and the passing of a time period. Each governance policy may include more than one requirement. At least one of the requirements may have an application date that is different from the other requirements. In another embodiment, each governance policy is associated with a class of records.

Each management input describes a requirement that may arise from legal, business, and/or information technology considerations. In one embodiment, the legal considerations arise from more than one jurisdiction. The requirement describes how a governance function must be carried out with respect to a record class.

The microprocessors are also programmed to execute instructions of a control module. The control module is configured to receive a selection of one or more of the governance policies produced by the policy module and apply the selected governance polices to records created by a business division. In one embodiment, more than one governance policy is selected for a particular one of the records, and the selected governance policies are applied independently of each other to the particular one of the records. In another embodiment, the control module applies the modified policies to records captured after an effective date of the modified policies.

The application of the governance policy may include instructions to delete metadata associated with at least one of the records, instructions to delete full-text indexes belonging to at least one of the records, instructions to request confirmation from an administrator prior to acting on one of the records, and/or instructions to move one of the records from the record repository to another location. In another embodiment, the another location is a record repository.

In one embodiment, the control module may also be configured to both receive notification of an occurrence of a business event, and recognize the notification as warranting triggering application of the governance policy.

The record repository stores the records created by the business division. The repository is responsive to the control module's application of the selected governance policies by storing, imposing immutability on, imposing mutability on, or deleting records according to the selected policies.

The communications network connects the microprocessors and the record repository to facilitate receipt of management inputs, and the selection and application of governance policies.

In one embodiment of the invention, icons may appear in a file plan. The icons correspond to records of a business unit. The file plan is a graphical representation of a hierarchical organization of icons corresponding to record classes, folders, sub-folders, and records. Each file plan may be associated with a jurisdiction and a set of governance policies representing the governance policies applicable in that jurisdiction. Some icons may represent one or more of the record classes as defined in the policy module. Each record class may correspond to a unique type of record, such that each type of record identifies a particular business function. Some icons corresponding to folders and sub-folders represent organizational units of records having common features.

In another embodiment of the invention, the system may have an editor module. The editor module allows for modification of a governance policy. After the editor module is used, a new modified governance policy may be produced.

The invention may also be embodied as a computer-based method for managing records. The method comprises providing one or more microprocessors, a record repository, and a communications network. The method also comprises receiving management inputs producing the governance policy, receiving a selection of one or more of the governance policies, and applying the governance policies to the records.

In one embodiment, the microprocessors are programmed to execute instructions of a policy module. The policy module is configured to receive a plurality of management inputs and to use the management inputs to produce a governance policy for a record class. Each management input may describe a requirement arising from legal, business, and/or information technology considerations. The requirement may describe how a governance function must be carried out with respect to the record class.

The microprocessors are also programmed to execute instructions of a control module. The control module is configured to receive a selection of one or more of the governance polices produced by the policy module and apply the selected governance policies to records created by a business division. In another embodiment, the control module is also configured to receive notification of an occurrence of a business event, and to recognize the notification as warranting triggering application of the governance policy. The step of applying the governance policies to the records may occur as a result of receiving such a notification.

The record repository may store records of the business division. The repository may also be responsive to the control module's application of the selected governance policies by storing, imposing immutability on, imposing mutability on, or deleting the records according to the selected governance policies.

The communications network connects the microprocessors and the record repository. The network may facilitate the receipt of the management inputs, and the selection and application of the governance policies.

In one embodiment, producing the governance policy may include adding a description of the management inputs and/or includes identifying jurisdictions for which the governance policy is applicable. Producing the governance policy may also include identifying a business event that triggers application of the governance policy.

In another embodiment, at least one of the governance policies may identify a duration after which the governance policy is applied. The step of applying the at least one governance policy may occur once the duration is achieved.

In one embodiment, at least one of the governance policies may identify at least one action that is triggered after the occurrence of an event and the passing of a time period. The step of applying the at least one governance policy occurs once both the event occurs and the time has passed.

In another embodiment, the method may further comprises associating each governance policy with a class of records.

In one embodiment, the method may further comprise applying the governance policies to delete metadata associated with at least one of the records, delete full-text indexes belonging to at least one of the records, requesting confirmation from an administrator prior to acting on one of the records, and/or moving one of the records from the record repository to another location. The another location may be another record repository.

In another embodiment, the step of receiving the selection may include receiving selections for more than one governance policy for a particular one of the records. The step of applying the selected governance policies may be executed independently of each other to the particular one of the records.

In one embodiment, the method may further comprise providing an editor module. The editor module may be used to modify at least one of the governance policies. The method may comprise the additional step of using the control module to apply a modified policy to records captured after an effective date of the modified policy. The method may also comprise the additional step of using the policy module to produce a modified governance policy after the editor module is used.

The present invention provides a system for creating and managing file plans within an entity and across the jurisdictions where the sub-entities operate, and for creating and enforcing through these file plans, composite and extensible lifecycle policies that apply to records. For the purposes of this application, the term composite means that rules for one record may include (but are not limited to): 1) how long to retain records within the custody of the entity; 2) how to dispose of the records; 3) how long to retain certain metadata of records; 4) how to dispose of the metadata; 5) how long to keep records on specific storage devices and record repositories; and 6) when to move the records to other storage devices and record repositories.

In contrast to the prior art, the present invention uses dynamic multijurisdictional file plans which can be populated in both a central top-down and a federated bottom-up process. The present invention utilizes jurisdiction-aware policy definitions that are directly available within the file plans in the sub-entities of a corporation and may be used at sub-entity level to manage the lifecycle of the records. The jurisdiction-aware policy definitions are directly available within the file plans in the sub-entities of a corporation and may be used at sub-entity level to manage the lifecycle of the records.

The system can apply lifecycle controls and actions using a central policy management component, a federated enforcement component, and the concept of record repository agnosticism, which is the ability to apply governance controls on content while it remains in-place and in the custody of another system. Content is a generic term that refers to information that has been packaged for the purpose of use in business (e.g., documents, invoices, customer statements, reports, etc.)

The system uses an apparatus that may consist of two integrated modules, the Information Governance Policy Module (IGPM) and the Information Governance Control Module (IGCM). These modules can be deployed together on the same computer system or de-coupled and deployed on separate computer systems.

The IGPM may provide a central/corporate collaborative facility for the creation and management of a Master Classification and corresponding composite policies for governing information assets: retention, security, data privacy, discovery, storage, and audit. The composite policies are extensible in nature. This means that the entity may start with policies relating to retention and disposition and later extend these policies with other governance rules, example storage migration, retention and disposition of metadata, etc. The composite policies may also cater for the governance requirements of multiple jurisdictions. IGPM may also provide for the configuration and deployment of these policies across the entity. These definitions may be stored in a database.

The IGCM enables authorized operators in the sub-entities to access the classification and policy database, create and manage file plans, associate these file plans with jurisdictions, and manage within these file plans the records in the sub-entity's custody.

The file plans include hierarchies of record classes and folders under these classes in which records and other forms of information are organized and their lifecycle is managed.

The IGCM also allows these operators to manage the lifecycle of information and content in accordance with IG policies. It also enforces these policies across geographies and jurisdictions, platforms and applications. This can be done by generating lists of eligible and approved actions (i.e., triggered by the passing of lifecycle milestones) and (ii) actioning and enforcing the lifecycle actions associated with these milestones. Through the integration with IGPM, the file plans in IGCM can include a subset or all of the Record Classes defined in IGPM. The governance policies assigned to the Record Classes in each file plan reflect the associated jurisdiction.

Governance-related information lifecycle actions are enforced on content stored within a complex Information Technology (IT) infrastructure and across record repositories for structured and unstructured information. IGPM and IGCM may maintain an audit trail of the above activities.

Other features of the invention can be found in the following description, the enclosed claims and/or the attached drawings.

### BRIEF DESCRIPTION OF THE DRAWINGS

For a fuller understanding of the nature and objects of the invention, reference should be made to the accompanying drawings and the subsequent description. Briefly, the drawings are:

FIG. 1 illustrates the inputs to an system in keeping with the present invention which is the combination of the IGPM and IGCM modules, and an output from that apparatus. The figure depicts the corporate IG policy development with jurisdiction aware File Plan definition and deployment;

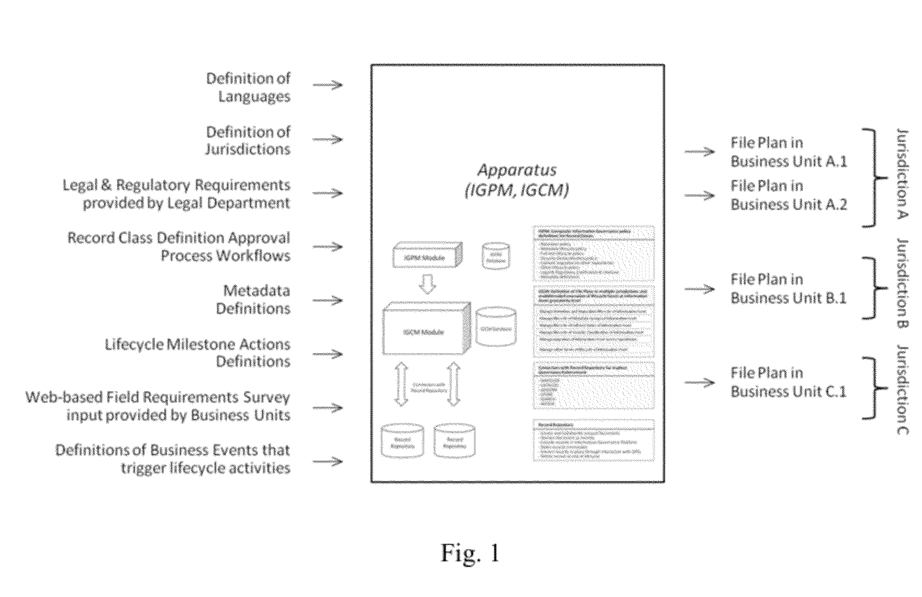

FIG. 2 illustrates the definition of the composite policies and rules in IGPM and their deployment in File Plans in the various jurisdictions in IGCM in keeping with the present invention. This figure depicts the system including the composite information governance policy definitions in IGPM, the multithreaded execution of lifecycle of information assets in File Plans in various jurisdictions in IGCM, and the In-Place Lifecycle Policy Enforcement Connectors; and,

FIG. 3 illustrates the inputs into the policy apparatus and the resulting composite policies in keeping with the present invention.

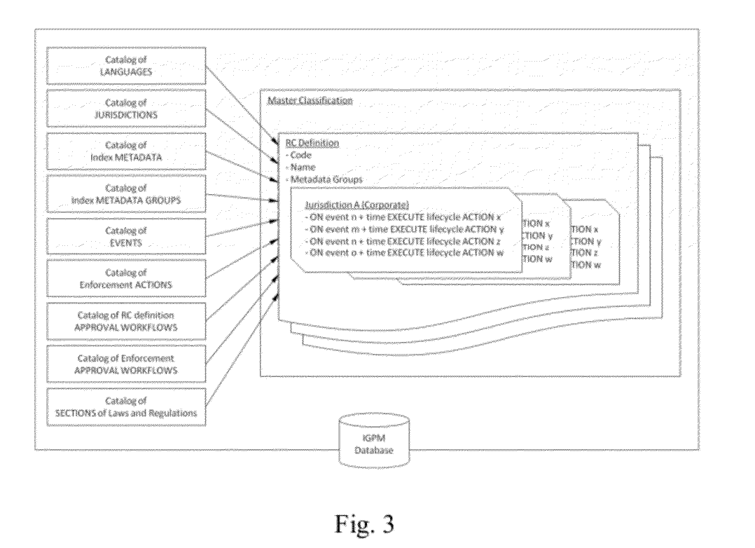

### FURTHER DESCRIPTION OF THE INVENTION

The present invention may be described with reference to (a) an input into an apparatus, (b) an apparatus, and (c) an output from that apparatus. It relates to the ability of the “invention” (and its modules) when used by authorized operators to utilize as input the contents of laws, regulations and the internal business requirements, to create from that input a Master Classification with Record Class definitions, composite governance policies for these record classes, variations top these policies reflecting jurisdictional differences, and File Plans in various jurisdictions containing classifications, folders, and records.

The input into the apparatus may include organizational information (jurisdictions, locations, etc.), legal research information, record class and metadata definition information, lifecycle action definitions, retention requirements from the business, and information about events that trigger intermediate and end-of-lifecycle actions.

The output from the apparatus may include specific file plans defined within the sub-entities each reflecting the classification structure and folder substructure required for them and the jurisdiction-specific governance policies for the records managed within each of these structures.

The present invention brings together disparate corporate processes related to IG policy development (including legal research, classification development, metadata definitions for information and record classes, event catalog, multiple lifecycle milestones), and to structure and mechanize these processes by deploying these policies within multiple jurisdictions in corresponding File Plans. The deployment of these policies within the File Plans takes the form of jurisdiction-specific policy parameters that are associated with Record Class definitions in the File Plan and are subsequently associated with individual records and folders that contain records within that File Plan. This association applies these policies to these records. In addition, these policies are composite in nature and may address simultaneously multiple facets of information lifecycle management.

In large and global entities, these processes may involve disparate teams both at the corporate level as well as at business operational levels across multiple jurisdictions. The invention also imbues agility and updatability to this process, something that is seriously lacking in the current manual processes.

Inputs. The input into the system in keeping with the invention, and which includes the IGCM and IGPM modules, includes (but is not limited to) the following: Definition of Languages for use in policies; Definition of Jurisdictions; Legal & Regulatory Requirements provided by Legal Departments; Business Requirements provided by Business Units; Record Class Definition Approval Process Workflows; Metadata Definitions; Lifecycle Milestone Action Definitions; Field Requirements Survey input provided by Business Units; and Definitions of Business Events that trigger lifecycle activities.

Authorized IGPM operators define the languages that can be used within the Master Classification and the definitions of the Information Governance policies. The languages may be identified by their ISO 639 and ISO 3166 codes.

One of the languages is designated in the IGPM as the Corporate Language (i.e. the language defined as being the default language within the business entity). For example, a U.S. global entity may define “English” as being the Corporate Language and then define additional languages that are to be supported within the Information Governance solution.

The importance of the Corporate Language definition is that as a minimum (i) all Record Class definitions and policies will be defined in that language and (ii) those definitions will be available in that language in all sub-entities. In addition, a jurisdiction that has its own language, for example Germany, may have the Record Class definitions and policies expressed in the German language.

Authorized IGPM operators may define the jurisdictions that the entity operates in. For example, operators may define the jurisdictions in which the entity and its sub-entities operate are catalogued by name. A jurisdiction may be a country, a state, a province, a canton, or any other types of legal domain, for example, the US, NY State, and France. The first jurisdiction defined is the Corporate jurisdiction, for example, USA for a US corporation and UK for a British corporation. The corporate jurisdiction is the jurisdiction which rules apply everywhere within the entity except for RCs in specific jurisdictions where there are laws and regulations that require the application of different information governance rules. The language designated as corporate language will apply to the RC definitions in each jurisdiction. In addition, jurisdictions may be assigned additional languages, example for a US corporation that has a global operation may have a Corporate jurisdiction in English, a US jurisdiction in English and Spanish, a Canadian jurisdiction in English and French, a German jurisdiction in English and German, and a Swiss jurisdiction in English, German, French, Italian, and Romansh. Once the jurisdictions are defined they become available for use within RC definitions. Once the languages are defined and assigned to the jurisdictions, they become available for use within RC definitions.

Authorized operators enter into IGPM the laws and regulations that may apply to the entity. The information may be entered section by section of a particular law or regulation. The laws and regulations may persist in the database. The laws and regulations may be broken down section by section. Each law and regulation section may be referenced in the database with the following index metadata: Name of law or regulation, provenance of law or regulation, issuing date of law or regulation, issuing authority of law or regulation, jurisdiction in which the law or regulation applies (which may be mapped to the jurisdiction catalogue), section ID, section title, section text, and the governance lifecycle constraints defined and required by that section. The lifecycle constraints may include one or more events that trigger the retention, minimum retention, maximum retention, and one or more enforcement actions. The laws and regulations content may be imported into IGPM using an XML format

The importance of having these requirements defined within IGPM is that one or multiple laws and regulations may be associated with each Record Class definition. That helps justify the legal reasons for setting up a particular policy and imposes the retention constraints defined by those laws and regulations to the Record Class lifecycle definition in the particular jurisdiction.

The IT requirements for the lifecycle of information assets (by RC) may include migration of information assets across storage devices and record repositories, retention and disposition of the full-text indexes of records, and security declassification.

Record Class Definition, Lifecycle Milestone & Action Definition Approval Process Workflows. IGPM provides a collaborative facility for the development of the Master Classification and its RC policy definitions. The Master Classification is a list of Record Classes which are unique record types (e.g., Invoice, Purchase Order, etc.) organized in a hierarchy, often a functional hierarchy. This collaborative facility incorporates a policy approval workflow process.

IGPM may allow the administrator to create one or multiple RC definition approval workflows. Each workflow may consist of one or multiple approval steps which may be sequenced in a mix of serial and parallel routes. Each routing step may have a specific addressee and may define which portions of the RC definitions the addressee has rights to edit. For example, Legal may have rights to edit the law and regulation associations with the RC definition but not to any other aspect of the RC definition. Once an RC approval workflow is defined, it becomes accessible for use in RC definitions

IGPM may allow the administrator to create one or multiple lifecycle ACTION approval workflows. Each workflow may consist of one or multiple approval steps which may be sequenced in a mix of serial and parallel routes. Each routing step may have a specific addressee, for example, Head of HR Department. Once an ACTION approval workflow is defined, it becomes accessible for use in RC definitions

Authorized IGPM operators may collaborate through the RC approval workflow to finalize the definitions of the RC and its policies and eventually approve it and publish for use in the field in the Business Units.

Metadata Definitions. The authorized operator defines standardized and normalized metadata definitions for Record Classes—these definitions become available system-wide. The metadata definitions include validation rules. These metadata definitions may cover the index elements that are deemed for business reasons to be descriptive of the record, for example, “Invoice Number” and “Supplier Name” for an invoice. The validation rules may specify whether the metadata value can be numeric value, alphanumeric value, date and time, or any other type. This may be needed to enforce data quality levels on entered data. Finally, the metadata definitions may be organized in metadata groups which in turn may be assigned to Record Class definitions. These groups may be used in the lifecycle definitions to control the lifecycle of clusters of metadata collectively, for example, personally identifiable metadata such as Employee Family Name, Social Security Number.

Lifecycle Milestone Actions Definitions. This input is provided to IGPM by the entity's records manager and may consist of a list record lifecycle actions that may be used in the definition of the RC lifecycle actions, for example: End of record lifecycle disposition action, end of record lifecycle disposition with prior approval of record custodians, destruction of specific record metadata sets, destruction of full-text index of some records, movement of records to another storage device or record repository, and reduction in the security classification level.

Field Requirements Surveys by Business Units. IGPM provides the ability for the administrators in the sub-entities to submit to the entity's corporate governance team web-based surveys representing their record inventory position. Users in a Business Unit of the entity (sub-entity) may document their governance requirements (retention, confidentiality, etc.) and submit them (survey) to the central Records Management group.

A web-based survey acts as a way for the administrators in the sub-entities to send requests to the entity's corporate team to create new RC definitions or jurisdiction-specific variations to existing RC definitions. The web-based survey may include the following information: Date of survey submission, the sub-entity's administrator user name, desired name and class code of new RC, desired (business requirements) lifecycle rules to be defined for records of such class, recordkeeping lifecycle (including event(s) that trigger the start of the retention period, retention period, and approved disposition action), metadata scope and lifecycle, security classification requirements throughout lifecycle (e.g., security clearance declassification process), information about how such records are created and managed, information about the business processes that involve such records, and information about the volume of records of such class created and consumed within the sub-entity.

The survey submissions are persisted in the IGPM database, survey by survey and field by field. The sub-entity's administrator can track the progress of the submitted survey in terms of whether the request has been approved or whether the IGPM administrator has rejected the request. IGPM lists the received surveys by provenance and by type, and then maps the survey contents field by field to the RC definition index fields they correspond to, example, the Suggested Record Class Name=RC Name, and the Suggested Record Class Retention Rules—Record Retention Rule in the lifecycle.

The entity's administrator may select multiple submissions which he or she deems related to the same RC definition draft. He or she may display the field values of the selected submission next to their corresponding RC index field. He or she may select a particular index value from one survey and make it an index value for the RC definition. As indicated in Example 15 below, the survey submitters in the sub-entity may track the status of their submission and whether they have been accepted or rejected.

IGPM creates a hierarchy of record classifications consisting of Parent RCs, Children RCs, and Grandchildren RCs, etc. (to an unlimited depth level). IGPM may enforce an inheritance scheme (from the Parent RC to the Child RC) on the values of certain indexes in the RC definition. For example, the RC code of the Child RC may be based on the code of the Parent RC. In another example, some index metadata values of a Child RC may be inherited from the corresponding metadata fields in the Parent RC.

Business Events Definitions. This input is provided to IGPM by the entity's records manager, the sub-entities' records administrators, IT and other areas within the entity. It includes a list of the events that impact of the lifecycle of information assets and the unique information asset metadata that identify the affected information asset. For example:
Event ID Name=“END_OF_EMPLOYMENT”
Execution Parameter=“EMPLOYEE ID”
   An example of such an event may be as follows:
End of Contract
   Metadata may be Contract Number
End of Equipment Maintenance
   Metadata may be Equipment ID
End of Mortgage
   Metadata may be Mortgage Number
End of Quarter
   No metadata is required

The invention consists of a method based on a computer system for creating for an entity a Master Classification (one or multiple) of types of records, referred to as Record Classes (RC), and also for creating multiple associated File Plans based on that classification. The File Plans are used by the sub-entities to organize and govern (control the lifecycle of) their records. The method also provides for the creation of composite policies for the Record Classes for the purpose of governing information assets: retention, security, data privacy, discovery, storage, and audit, while catering for jurisdictional differences in these policies. The system in the invention may include two integrated modules in order to achieve the above.

The first is an Information Governance Policy Module (IGPM) which may be used to create a Master Classification (MC) of Record Classes (RC) for the entity and corresponding governance rules for each of them. Multiple sets of rules may be created for each RC reflecting the governance requirements of each jurisdiction covered by the entity.

The second is an Information Governance Control Module (IGCM) which allows administrators in the sub-entities to create and manage file plans using the RC definitions created and managed in IGPM, associate these file plans with jurisdictions, and manage the sub-entity's records within them. It also allows these administrators to manage the lifecycle of these records in accordance with the policies defined in IGPM, and enforce these rules within geographies and jurisdictions, platforms and applications.

The apparatus may be operated by a number of users with different profiles and perspectives. The list of users may include, but is not limited to:

User #01—End-User in the sub-entity: The average user within a sub-entity who receives documents and records, creates them and exchanges them with internal and external parties.

User #02—Records Administrator in the sub-entity: The individual within the sub-entity, assigned the responsibility of carrying out the Information Governance Policies.

User #03—Corporate Records Manager: The individual within the headquarters who may be responsible for managing the process of creating the Information Governance Policies, ensuring that the policies are up to date, ensuring the policies are made available to the field Records Management personnel.

User #04—Governance Steering Committee Member: The corporate officers responsible for overseeing and managing Information Governance program and for defining the policies and rules for governing information.

User #05—System Administrator: The individual responsible for configuring and maintain the technical aspects of the governance platform (the invention).

IGPM provides a centralized collaborative facility for the creation and management of a Master Classification of Record Classes and corresponding composite policies governing information retention, security, data privacy, discovery, storage, and audit, while catering for jurisdictional differences in these policies. It also provides for the configuration and deployment of these policies across the entity.

Policies may be based on legal and regulatory requirements in various jurisdictions including:

Laws and regulations: Laws and regulations that may be applicable to the entity may be stored into the IGPM, broken down section by section and indexed using a number of attributes, including but not limited to: issuing authority, jurisdictional scope, and status.

Constraints defined by laws and regulations: The constraints define the events that start the retention, the minimum and maximum retention periods, and the actions at the end of lifecycle, as required by laws or regulations and imposed on the Record Class definitions. Associating laws and regulations with an RC, imposes the constraints defined for these laws and regulations on RC policy definition.

Version control for laws and regulations: IGPM provides a law and regulation version control function to maintain the attributes of superseding versions of laws and regulations and apply them to the information being managed.

Policies may be also based on the requirements of business sub-entities covering operational information lifecycle needs. This may be done using web-based field requirement surveys. This capability allows the field users of the entity to submit their requirements for Master Classification entries based on their business requirements. The survey covers the record inventory function (normally performed manually by Records Management consultants).

Authorized operators may use the above input to create a Master Classification and associated File Plans. The Master Classification is an organized hierarchy of unique

Record Classes and representing the business functions of the entity and the unique types of records that are in use within these business functions. Each RC in this hierarchy comprises comprehensive structured definitions that may include the following:
RC numeric or alphanumeric code
RC name description
The RC definition approval workflow to follow
An indicator whether the RC is a “Default RC”, this means that this particular RC will appear automatically in every File Plan created in the sub-entities in IGCM
The sections of particular laws and regulations that require or recommend specific governance controls on records associated with such RC
The jurisdictions in which records associated with such RC are created and used.
The governance rules that may apply to the records associated with such RC, in each of these jurisdictions where these rules apply

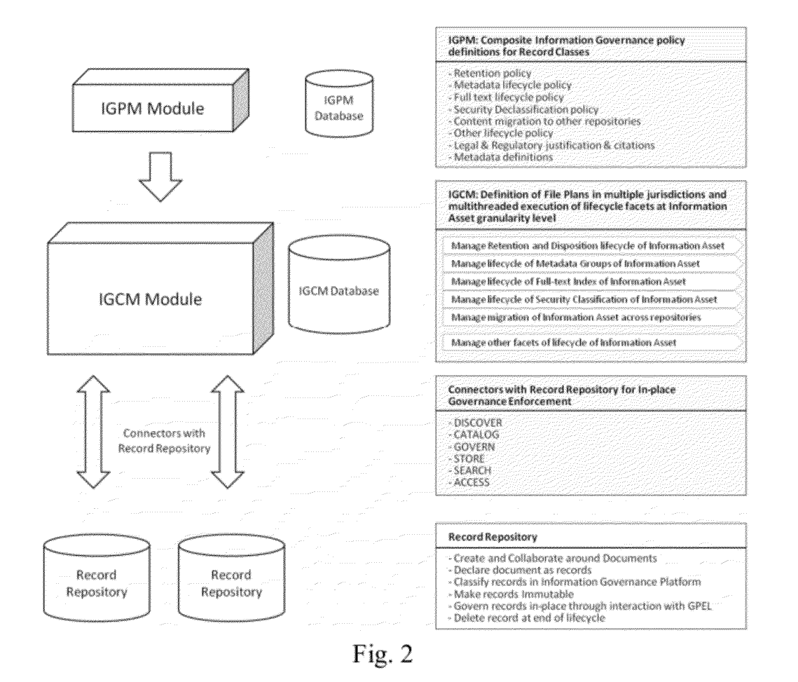

Composite Lifecycle Policies for RCs. IG policies may be composite in nature and take into consideration multiple facets of the information lifecycle—see FIG. 2. The term “composite” refers to the multipart nature of RC policy definitions as described in the list below and illustrated in FIG. 2:
Retention and disposition: This defines the event that starts the retention period, the retention period itself and the end of lifecycle action to be performed at the end of the lifecycle.
   Example: On end_of_contract+7 years=dispose_of_record
Data privacy: This defines the lifecycle of data privacy metadata independently of the lifecycle of the information item or record.
   Example: On end_of_employment+2 years=destroy_personally_identifiable_information
Security declassification: This defines the lifecycle of the security classification level settings.
   Example: On end_of_mission+20 years=declassify_record
Migration across storage tiers: This defines the content migration actions to be performed as part of the lifecycle of the record.
   Example: On end_of_contract+2 years=move_content_to_tier2_storage
Lifecycle of the full-text indexes belonging to information items: This defines the lifecycle of the content full-text index independently of the lifecycle of the information item or record.
   Example: On end_of_contract+1 year=delete_fulltext_index_of_record

RC definition inheritance schema. IGPM provides comprehensive inheritance capabilities across the hierarchy of RCs. The word “inheritance” is used here to refer to the ability of a RC in the classification hierarchy to automatically acquire metadata values from its RC parents in the Master Classification hierarchy. For example, a RC may “inherit” the Security Classification value from its parent. Thus, if the parent RC is defined to have a Security Classification of “Top Secret”, the child RC will automatically become “Top Secret” as well. This inheritance capability may cover the following: Metadata values, security classification values, RC code structure, lifecycle policies, and many others. For example, if Security Classification of parent RC is Secret, then Security Classification of RC is also Secret.

RC definitions for multiple jurisdictions. An entity may have one Master Classification and multiple instances of the policies (one per jurisdiction). Once the Master Classification is created, local Records Managers in the field in various jurisdictions can request variations to the policies defined in the Master Classification. The Master Classification and its policies can be expressed in multiple languages. Each jurisdiction can be associated with one or multiple languages. Policies take the form of a Master Classification comprising unique and distinct definitions of Record Classes (and lifecycle policies) that reflect the major functions of the entity. Record Class definitions incorporate metadata definitions for each Record Class. There may also be a master list of lifecycle triggering events.

RC policy definition details. IGPM allows authorized operators through its collaborative processes to manage the Master Classification (add new RCs, close RCs, create new versions of RCs, etc.) and its policy updates and versions, and maintains an audit trail of its activities.

The governance rules described above are expressed and persisted in IGPM in narrative form (human readable) as well as in the form of coded parameters that may be used directly by the lifecycle enforcement engine.

The rules defined for each of the lifecycle facets of the RCs in IGPM may be based on the following formulas:
ON event+time, EXECUTE action
The event defined in the rule must be selected from the EVENT catalogue
The time period defined in the rule may be a numeric value and unit—the unit may be day, month, year
The action defined in the rule may be selected from the ACTIONS catalogue
   Rules based on the above formula may be defined for each lifecycle facet of each RC definition, including the following:
Retention and disposition of records
Storage and migration of records across record repositories
Retention and disposition of specific record metadata
Rules for retaining and disposing of the record's full-text indexes

Multiple lifecycle rules may be defined for each facet of the definition of an RC in IGPM and this for each of the jurisdictions where this RC will apply, for example, the following is a retention and disposition rule of a record:
RC=Employee Records and Jurisdiction USA
   ON employee_retirement+7 years EXECUTE dispose of employee records APPLICABLE_ON record
   ON employee_termination+10 years EXECUTE dispose of employee records after HR Manager approval APPLICABLE_ON record
   ON employee_retirement EXECUTE migrate employee records to off-line storage (or off-site storage for physical records) APPLICABLE_ON record
RC=Employee Records and Jurisdiction France
   ON employee_retirement+20 years EXECUTE dispose of employee records after HR manager approval APPLICABLE_ON folder
   ON employee_retirement+5 years EXECUTE dispose of employee metadata protected by Privacy Laws APPLICABLE_ON folder

The APPLICABLE_ON element in the lifecycle formula determines if the lifecycle rule will apply to the individual record or to the folder that contains the record in the File Plan in IGCM.

Authorized IGPM operators use the contents of the Field Requirements Surveys to create new Record Class definitions within the Master Classification or create new versions of existing Record Classes:
Definition of Record Class
Definition of metadata for records to which RC is assigned
Definition of different facets of lifecycle policies, which may be based on expressions, such as:
   ON Event_ID+Time EXECUTE Lifecycle_Milestone_Action on Record Element
Each facet of the record lifecycle may have multiple policies assigned to it, for example:
   ON EVENT1+Time1 OR ON Event2+Time2 OR ON Event3+Time3 DELETE Record Element

A standardized catalogue of EVENTS may be created and managed in IGPM, and thereof used within the definitions of the RC lifecycle rules also in IGPM. Each EVENT may include the following attributes: Event Code (numeric or alphanumeric), Event Name, or Record Metadata associated with the Event (e.g., Employee_ID for “employee_retirement”).

Each RC definition and jurisdiction variation thereof may be configured with a different mix of EVENTS. The execution of certain events may be triggered by external business applications as described below.

A standardized catalogue of lifecycle enforcement ACTIONS may be created and managed in IGPM, and thereof used within the definitions of the RC lifecycle rules also in IGPM. Each enforcement ACTION may include the following index attributes: Action Code (numeric or alphanumeric), or Action Name.

Each RC definition and jurisdiction variation thereof may be configured with a different mix of ACTIONS In addition, IGPM comes preconfigured with a number of enforcement actions, including: Dispose of record, Dispose of record after pre-approval, Transfer of record, Delete metadata of record, and Delete full text index of record.

Interaction Of Laws With Lifecycle Rules. One or multiple law and regulation sections defined in IGPM may be associated with a lifecycle rule that applies within a jurisdiction and for a particular RC:
For the record retention and disposition rule or rules in particular, when such an association is created, the minimum and maximum lifecycle constraints described above may be imposed on the particular record lifecycle rule
If the lifecycle rule defined falls outside minimum and maximum lifecycle constraints, the definition of the RC will fail to validate
If the IGPM user performing the action is an authorized user (example Legal Department), he or she can force IGPM to accept the offending lifecycle definition but must also provide a textual justification for that override
IGPM may keep a detailed audit trail of that activity
   Who defined the lifecycle rule and when
   Who forced the override and when

Publication of RC Definitions. The IGPM administrator publishes the RC definitions that have been approved by the addressees of the workflows. While an RC is within the approval workflow process, its status is visually indicated as such in the Master Classification view in IGPM. Once an RC is published it become available for use within the sub-entities in IGCM and the File Plans managed within it.

IGCM enables authorized operators in the field to manage the lifecycle of information and content in accordance with the composite IG policies, and enforce these policies across geographies and jurisdictions, platforms and applications, record repositories and data warehouses. For example, operators can create and manage File Plans in various Business Units within a jurisdiction. Authorized users within the Business Units of the entity can create local File Plans. These may be sub-sets of the Master Classification along with the appropriate policies that apply within the jurisdiction. The File Plans may be used to create folders within them and manage records within the folders.

Operators may also assign security to elements of File Plans. The security assignments (see list below) may be cumulative in effect, in other words, a user must meet all assigned security restrictions to be able to access the information item in the File Plan.
Access Control List (ACL)
Security Classification (not limited to):
   Top Secret
   Secret
   Confidential
   Restricted
   etc.
Security Caveats (not limited to)—these additional restrictive designations:
   FOUO (For Official Use Only)
   COMSEC (Communication Security)
   CNWDI (Critical Nuclear Weapon Design Information)
   NOFORN (Not Releasable to Foreign Nationals)

Operators may apply security on information managed within these File Plans. The lifecycle of File Plan elements may be governed by jurisdiction-specific rules that have been propagated by IGPM and created in the File Plan. The operators may define mapping of metadata belonging to information in IGCM and corresponding information in integrated record repositories. This mapping enables the definition of corresponding metadata elements between the RC definition in the File Plan and corresponding metadata in the supported record repository. For example, in IGPM and IGCM an employee may be reference using a metadata attribute called EMP_NBR, however one of the content repositories that has been integrated with IGCM may reference the employee using another metadata attribute such as EMPID. The metadata mapping mechanism in IGCM enables IGCM to identify the corresponding content in the record repositories and enforce the governance actions on them.

Operators may provide advanced functions for lifecycle planning, including identifying information items that have eligible lifecycle actions in specified period of time, and provide simulation capabilities. For example, operators may show which records will be impacted from a lifecycle point of view (and how) if a particular event has occurred, example which records will be impacted and how if the end_of_contract event for a particular contact occurrence.

Operators may execute and manage approvals for eligible lifecycle actions as defined in IG policies propagated by IGPM. Some of the information items that have eligible lifecycle actions may require approvals prior to the enforcement of the actions on them. The IGCM provides a workflow functionality that supports these approval processes. Operators may maintain audit trail of the above activities.

Authorized IGCM administrators in the sub-entities may create File Plans to manage records in their custody. Authorized IGCM operator in the sub-entity (within a specific Jurisdiction) may create the “appropriate” File Plan for his/her sub-entity. Attributes of File Plan may include: Name of File Plan, Description, Jurisdiction, Content Repositories, Approving Period for Lifecycle Enforcement.

The File Plan may be a hierarchical arrangement of RC Groups, RCs within them, folders within the RCs, and records within the folders. IGCM automatically adds to the File Plan the RCs that have been defined as Defaults in IGPM. An authorized operator may manually select other RCs from the Master Classification and add them to File Plan.

The following attributes of the selected RC Group and RC defined within IGPM become effective within the File Plan in IGCM (including but not limited to): IG policies defined for said Jurisdiction, Security Classification attributes, and ACL security attributes.

RC definitions added to the File Plan become available in the language definitions defined for the jurisdiction that has been associated with the File Plan. RC definitions added to the File Plan (either automatically because they are Default RCs or manually because the administrator in the sub-entity has added them to the File Plan) and the information governance lifecycle rules defined for them in IGPM take effect within the File Plan in IGCM. Only the Default RCs defined for the Global jurisdiction or the specific local jurisdiction of the sub-entity (and associated with the File Plan) may be created. The list of approved and published RC definitions for that jurisdictions are also made available for the administrator at the sub-entity to select and add to the File Plan. The administrator may choose any number of these RC definitions based on the business function of the sub-entity.

The IGCM administrator in the sub-entity may create folders within the RCs added to the File Plan. Users or processes connected to IGCM may capture records into the File Plans. The term “capture” refers to the action of creating a catalogue entry within a specific folder in the File Plan. This catalogue entry corresponds to the record. The record objects themselves may remain in-place in their original record repository or may be ingested in the archive repository of the invention.

The security classification attributes define the classes of security clearance or access types (example Top Secret, Secret, Confidential, etc.)—refer to descriptions in the [Apparatus][IGCM] sub-section.

Authorized IGCM operators can assign additional security attributes to a File Plan and its elements. For example, Security Classification attributes, and ACL security attributes.

An external application may trigger the execution of an EVENT defined in IGPM and instantiated in one or multiple File Plans located in one or multiple instances of IGCM in the sub-entities. A business event may occur in an external application or process, example: “Employee_Retirement” for a particular employee referenced by his or her Employee ID or “End_of_Contract” for a particular vendor contract referenced by the Contract Number. The external application or process may notify one or multiple IGCM instances deployed within the sub-entities of the occurrence of such EVENT. Notifications may specify the EVENT ID as defined in the EVENTS Catalog (details in Example 10) and the metadata associated with that event, for example “Employee_Retirement” for Employee ID 123. The notification may take place programmatically via a Web Services call from the application or process to the IGCM instances.

IGCM reacts to this EVENT notification by executing the corresponding EVENT for the relevant records (identified by the metadata); these are the records that meet the following criteria: Records' assigned RCs use this particular EVENT in their lifecycle definition, or Records that match the Record Metadata provided via the notification.

The execution of the EVENT in IGCM may trigger one or multiple lifecycle activities, example: Start of record retention period, Migration of records to different record repository systems, and/or Start of record metadata retention period.

One of the following events may trigger a review cycle for the RC definition for the purpose of creating a new version of that RC: A change in a particular law or jurisdiction may automatically trigger a review cycle for all RC definitions associated with that particular law or regulation, the IGPM administrator may manually trigger a review cycle for an RC definition and any of its jurisdictional variations, or the review cycle predefined in IGPM (example 2 years) may automatically trigger a review of an RC definition.

The IGPM administrator manages the review of an RC definition (e.g., changing the retention period or the lifecycle actions) and sends the new version of the RC definition for approval using the workflow described above.

The IGPM administrator may edit existing RC definitions, create new versions thereof, run these versions through the approval process, and eventually publish the new versions of these RC definitions. The changes may impact lifecycle rules assigned to the Global jurisdiction or to any other jurisdiction. Through the integration of IGPM and IGCM, the new version of the RC becomes available in IGCM as soon as it is published in IGPM. The IGCM administrators responsible for the File Plans may choose to synchronize the definitions of the new RC versions with their corresponding RC definitions in the File Plan. The new RC version may be attributed an effective date in IGPM. This means that records associated with that RC and are catalogued in the File Plans in IGCM after this effective date will be governed according to the new and modified rule definitions.

The IGPM administrator may close an RC in the Master Classification in IGPM. If the IGCM administrator updates the corresponding RC definition in a File Plan he or she manages, the RC and the whole folder structure under that RC entry in the File Plan becomes closed. Records already catalogued under that RC element are unaffected. No new records can be added to that branch of the File Plan tree.

The output from the system may be a set of fully functional File Plans deployed within the various jurisdictions, for example: a File Plan for Human Resources Department at Corporate headquarters, a File Plan for Human Resources Department in the UK Division, and/or a File Plan for Finance Department in German Subsidiary.

Each File Plan may be configured with a specific set of RCs and corresponding governance policies that apply within the specific jurisdiction. Authorized IGCM operators can use the File Plans and their elements to:
Create a folder structure within the RC Group and RC hierarchy—the folder structure is a hierarchy of folders and sub-folders containing records.
Capture documents and other forms of information within the folder structure
Navigate and search through the File Plan structure to access the content (generic term that refers to information that has been packaged for the purpose of use in business, example document (invoice, customer statement, report, etc.))

Authorized IGCM operators can perform the lifecycle management tasks on the File Plans including:
Records screening and scheduling to identify eligible lifecycle actions
Process lifecycle action approvals
Apply lifecycle enforcement on eligible and approved lifecycle actions
Apply and release holds (the ability to suspend the lifecycle of a record due to a litigation or investigation that involves that record, and subsequently resume that lifecycle when the litigation or investigation ends).

Embodiments of the present invention also include, without limitation, the following examples and combinations thereof:

### Example 1

The invention consists of a method based on a computer system for creating for an entity one or multiple Master Classifications of types of records, referred to as Record Classes (RC), and multiple and associated File Plans that are based on that classification. the policies are composite in nature and may comprise multiple sets of such policies to cater for the differences in policy requirements in different jurisdictions. The File Plans are used by the sub-entities of that entity to organize and govern (control the lifecycle of) their records. The invention uses two integrated modules based on computer systems in order to achieve the above: The first is an Information Governance Policy Module (IGPM) which may be used to create a Master Classification (MC) of Record Classes (RC) for the entity and corresponding governance rules for each of them. Multiple sets of rules may be created for each RC reflecting the governance requirements of each jurisdiction covered by the entity. The second is an Information Governance Control Module (IGCM) which allows administrators in the sub-entities to create and manage file plans using the RC definitions created in IGPM, associate these file plans with jurisdictions, and manage the sub-entity's records within them. It also allows these administrators to manage the lifecycle of these records in accordance with the policies defined in IGPM, and enforce these rules within geographies and jurisdictions, platforms and applications.

### Example 2

The method of claim 1, wherein the Master Classification in IGPM is an organized hierarchy of unique Record Classes and representing the business functions of the entity and the unique types of records that are in use within these business functions. Each RC in this hierarchy comprises comprehensive structured definitions that may include the following:
RC numeric or alphanumeric code
RC name description
The RC definition approval workflow to follow (details in claim 13)
An indicator whether the RC is a “Default RC”, this means that this particular RC will appear automatically in every File Plan created in the sub-entities in IGCM (details in claim 19)
The sections of particular laws and regulations that require or recommend specific governance controls on records associated with such RC (details in claim 7)
The jurisdictions in which records associated with such RC are created and used (details in claim 6).
The composite governance rules that may apply to records associated with such RC, in each of these jurisdictions where these rules apply

### Example 3

The method of claim 1, wherein the rules defined for each individual RC in IGPM may cover multiple lifecycle facets of information governance controls. This may include the following:
Rules for retaining and disposing of records associated with such RC
Rules for storing and migrating these records across record repositories
Rules for retaining and disposing of specific metadata belonging to these records
Rules for retaining and disposing of the full-text indexes belonging to the record
   The composite governance rules described above are integrated together in each RC definition and for each jurisdiction in which they apply. These composite policies and rules are also acted upon by IGCM in a multithreaded manner where IGCM tracks various threads of eligible lifecycle actions for records associated with each RC in each of the jurisdictions.

### Example 4

The method of Example 1, wherein the composite governance rules described above are expressed and are persisted in IGPM in narrative form (human readable) as well as in the form of coded parameters that may be used directly by the lifecycle enforcement engine.

### Example 5

The method in Example 1, wherein the languages supported in the jurisdictions in which the entity operates are catalogued in IGPM:
Each language is defined using its name, example English, and its ISO 639 and ISO 3166 codes.
One of the languages is designated as the “Corporate” language of the entity; this means that RC definitions are defined in that language first (Details in Example 6).

### Example 6

The methods in Example 1 and Example 5, wherein the jurisdictions in which the entity operates are defined in IGPM:
The jurisdictions in which the entity and its sub-entities operate are catalogued by name.
A jurisdiction may be a country, a state, a province, a canton, or any other types of legal domain, example US, NY State, and France.
The first jurisdiction defined is the Corporate jurisdiction, example USA for a US corporation and UK for a British corporation.
The corporate jurisdiction is the jurisdiction which rules apply everywhere within the entity except for RCs in specific jurisdictions where there are laws and regulations that require the application of different information governance rules.
The language designated as corporate language will apply to the RC definitions in each jurisdiction.
In addition, jurisdictions may be assigned additional languages, example for a US corporation that has a global operation:
   Corporate jurisdiction: English
   US jurisdiction: English, Spanish
   Canadian jurisdiction: English, French
   German jurisdiction: English German
   Swiss jurisdiction: English, German, French, Italian, Romansh
Once the jurisdictions are defined they become available for use within RC definitions.
Once the languages are defined and assigned to the jurisdictions, they become available for use within RC definitions.

### Example 7

The methods of Example 1 and Example 2, wherein IGPM may be populated with a catalogue of Laws and Regulations that may belong to one or multiple jurisdictions:
The laws and regulations may be persisted in the database
The laws and regulations may be broken down section by section
Each law and regulation section may be referenced in the database with the following index metadata:
   Name of law or regulation
   Provenance of law or regulation
   Issuing date of law or regulation
   Issuing authority of law or regulation
   Jurisdiction in which the law or regulation applies (mapped to JURISDICTIONS catalogue
   Section ID
   Section Title
   Section Text
   Lifecycle Constraints defined and required by that section
      EVENT that triggers the retention
      Minimum retention
      Maximum retention
      Enforcement ACTION
The laws and regulations content may be imported into IGPM using an XML format
   The laws and regulations may be associated with individual threads of the lifecycle definitions of RCs in each of the jurisdictions.

### Example 8

The methods in Example 1 and Example 3, wherein the composite rules defined for each of the lifecycle facets of the RCs in IGPM are based on the following formula:
ON event+time EXECUTE action:
The event defined in the rule must be selected from the EVENT catalogue (details in Example 10)
The time period defined in the rule may be a numeric value and unit—the unit may be day, month, year
The action defined in the rule may be selected from the ACTIONS catalogue (details in Example 11)
   Rules based on the above formula may be defined for each lifecycle facet of each RC definition, including the following:
Retention and disposition of records
Storage and migration of records across record repositories
Retention and disposition of specific record metadata
Rules for retaining and disposing of the record's full-text indexes

### Example 9

The methods in Example 1, Example 3 and Example 8, wherein multiple lifecycle rules may be defined for each facet of the definition of an RC in IGPM and this for each of the jurisdictions where this RC will apply, example for a retention and disposition rule of a record:
RC=Employee Records and Jurisdiction USA
   ON employee_retirement+7 years EXECUTE dispose of employee records APPLICABLE_ON record
   ON employee_termination+10 years EXECUTE dispose of employee records after HR Manager approval APPLICABLE_ON record
   ON employee_retirement EXECUTE migrate employee records to off-line storage (or off-site storage for physical records) APPLICABLE_ON record
RC=Employee Records and Jurisdiction France
   ON employee_retirement+20 years EXECUTE dispose of employee records after HR manager approval APPLICABLE_ON folder
   ON employee_retirement+5 years EXECUTE dispose of employee metadata protected by Privacy Laws APPLICABLE_ON folder
      The APPLICABLE_ON element in the lifecycle formula determines if the lifecycle rule will apply to the individual record or to the folder that contains the record in the File Plan in IGCM.
      In the definitions above, each rule of an RC lifecycle represents a lifecycle thread that is defined in IGPM and tracked and managed by IGCM.

### Example 10

The methods in Example 1 and Example 9, wherein a standardized catalogue of EVENTS may be created and managed in IGPM, and thereof used within the definitions of the composite RC lifecycle rules also in IGPM. Each EVENT may include the following attributes:
Event Code (numeric or alphanumeric)
Event Name
Record Metadata associated with the Event (example Employee_ID for “employee_retirement”)
   Each RC definition and jurisdiction variation thereof may be configured with a different mix of EVENTS. Refer to Example 22 for details about triggering event execution by external business applications.

### Example 11

The methods in Example 1 and Example 9, wherein a standardized catalogue of lifecycle enforcement ACTIONS may be created and managed in IGPM, and thereof used within the definitions of the RC lifecycle rules also in IGPM. Each enforcement ACTION may include the following index attributes:
Action Code (numeric or alphanumeric)
Action Name
   Each RC definition and jurisdiction variation thereof may be configured with a different mix of ACTIONS. In addition, IGPM comes preconfigured with a number of enforcement actions, including:
Dispose of record
Dispose of record after pre-approval
Transfer of record
Delete metadata of record
Delete full text index of record

### Example 12

The methods of Example 1, Example 2 and Example 7, wherein one or multiple law and regulation sections defined in IGPM may be associated with the threads of the lifecycle rules that applies within a jurisdiction and for a particular RC:
For the record retention and disposition rule or rules in particular, when such an association is created, the minimum and maximum lifecycle constraints defined in Example 7 may be imposed on the particular record lifecycle rule thread
If the defined lifecycle rule defined falls outside minimum and maximum lifecycle constraints, the definition of the RC will fail to validate
If the IGPM user performing the action is an authorized user (example Legal Department), he or she can force IGPM to accept the offending lifecycle definition but must also provide a textual justification for that override
IGPM may keep a detailed audit trail of that activity
   Who defined the lifecycle rule and when
   Who forced the override and when

### Example 13

The methods in Example 1, Example 8, Example 9 and Example 11, wherein IGPM may allow the administrator to create one or multiple RC definition approval workflows:
Each workflow may consist of one or multiple approval steps which may be sequenced in a mix of serial and parallel routes.
Each routing step may have a specific addressee and may define which portions of the RC definitions the addressee has rights to edit
   Example Legal may have rights to edit the law and regulation associations with the RC definition but not to any other aspect of the RC definition
Once an RC approval workflow is defined, it becomes accessible for use in RC definitions

### Example 14

The methods in Example 1, Example 9 and Example 11, wherein IGPM may allow the administrator to create one or multiple lifecycle ACTION approval workflows:
Each workflow may consist of one or multiple approval steps which may be sequenced in a mix of serial and parallel routes.
Each routing step may have a specific addressee
   Example Head of HR Department
Once an ACTION approval workflow is defined, it becomes accessible for use in RC definitions

### Example 15

The method in Example 1, wherein IGPM provides the ability for the administrators in the sub-entities to submit to the entity's corporate governance team web-based surveys representing their record inventory position.
The web-based survey acts as a way for the administrators in the sub-entities to send requests to the entity's corporate team to create new RC definitions or jurisdiction-specific variations to existing RC definitions
The web-based survey may include the following information:
   Date of survey submission
   The sub-entity's administrator user name
   Desired name and class code of new RC
   Desired (business requirements) lifecycle rules to be defined for records of such class
   Information about how such records are created and managed
   Information about the business processes that involve such records
   Information about the volume of records of such class created and consumed within the sub-entity
The survey submissions are persisted in the IGPM database, survey by survey and field by field
The sub-entity's administrator of the sub-entity can track the progress of the submitted survey in terms of whether the request has been approved or whether the IGPM administrator has rejected the request.

### Example 16

The method in Example 1 and Example 15, wherein IGPM lists the received surveys by provenance and by type, and then maps the survey contents field by field to the RC definition index fields they correspond to, example:
Suggested Record Class Name=RC Name
Suggested Record Class Retention Rules—Record Retention Rule in the lifecycle
   The entity's administrator may select multiple submissions which he or she deems related to the same RC definition draft:
He or she may display the field values of the selected submission next to their corresponding RC index field
He or she may select a particular index value from one survey and make it an index value for the RC definition
As indicated in Example 15, the survey submitters in the sub-entity may track the status of their submission and whether they have been accepted or rejected

### Example 17

The methods in Example 1, Example 2 and Example 9, wherein IGPM creates a hierarchy of record classifications consisting of Parent RCs, Children RCs, and Grandchildren RCs (unlimited depth level). IGPM may enforce an inheritance scheme (from the Parent RC to the Child RC) on the values of certain indexes in the RC definition:
The RC code of the Child RC may be based on the code of the Parent RC
Some index metadata values of a Child RC may be inherited from the corresponding metadata fields in the Parent RC

### Example 18

The methods in Example 1, Example 2 and Example 9, wherein the IGPM administrator publishes the RC definitions that have been approved by the addressees of the workflows.
While an RC is within the approval workflow process, its status is visually indicated as such in the Master Classification view in IGPM.
Once an RC is published it become available for use within the sub-entities in IGCM and the File Plans managed within it

### Example 19

The methods in Example 1 and Example 18, wherein the IGCM administrators in the sub-entities may create File Plans to manage the records in their custody:
Each File Plan may consist of a hierarchy of RCs, Folders and Records within them
Each File Plan may be associated with a specific sub-entity and a specific jurisdiction
When File Plans are first created, the Default RCs defined in IGPM are automatically added to them by IGCM (details in Example 2).
   Only the Default RCs defined for the Global jurisdiction or the specific local jurisdiction of the sub-entity (and have been associated with the File Plan) may be created
The list of approved and published RC definitions for that jurisdictions are also made available for the administrator at the sub-entity to select and add to the File Plan
   The administrator may choose any number of these RC definitions based on the business function of the sub-entity.

### Example 20

The methods in Example 1, Example 18 and Example 19, wherein the IGCM administrators in the sub-entities may create File Plans to manage records in their custody:
RC definitions added to the File Plan become available in the language definitions defined for the jurisdiction that has been associated with the File Plan.
RC definitions added to the File Plan (either automatically because they are Default RCs or manually because the administrator in the sub-entity has added them to the File Plan) and the information governance lifecycle rules defined for them in IGPM take effect within the File Plan in IGCM.

### Example 21

The methods in Example 1, Example 2, and Example 19 where in the IGCM administrator in the sub-entity may create folders within the RCs added to the File Plan:
Users or processes connected to IGCM may capture records into the File Plans. The term capture refers to the action of creating a catalogue entry within a specific folder in the File Plan. This catalogue entry corresponds to the record.
The record objects themselves may remain in-place in their original record repository or may be ingested in the archive repository of the invention.

### Example 22

The methods in Example 1, Example 10 and Example 19, wherein an external application may trigger the execution of an EVENT defined in IGPM and instantiated in one or multiple File Plans located in one or multiple instances of IGCM in the sub-entities.
A business event may occur in an external application or process, example:
   “Employee_Retirement” for a particular employee referenced by his or her Employee ID
   “End_of_Contract” for a particular vendor contract referenced by the Contract Number
The external application or process may notify one or multiple IGCM instances deployed within the sub-entities of the occurrence of such EVENT
   Notifications may specify the EVENT ID as defined in the EVENTS Catalog (details in Example 10) and the metadata associated with that event—example “Employee_Retirement” for Employee ID 123
   The notification may take place programmatically via a Wed Services call from the application or process to the IGCM instances
IGCM reacts to this EVENT notification by executing the corresponding EVENT for the relevant records (identified by the metadata); these are the records that meet the following criteria:
   Records' assigned RCs use this particular EVENT in their lifecycle definition
   Records that match the Record Metadata provided via the notification
The execution of the EVENT in IGCM may trigger one or multiple lifecycle activities, example:
   Start of record retention period
   Migration of records to different record repository systems
   Start of record metadata retention period

### Example 23

The methods of Example 1, Example 2 and Example 9, wherein the following event may trigger a review cycle for the RC definition for the purpose of creating a new version of that RC definition:
A change in a particular law or jurisdiction may automatically trigger a review cycle for all RC definitions associated with that particular law or regulation
The IGPM administrator may manually trigger a review cycle for an RC definition and any of its jurisdictional variations
The review cycle predefined in IGPM (example 2 years) may automatically trigger a review of an RC definition.

### Example 24

The methods of Example 1, Example 2, Example 9 and Example 17, wherein the IGPM administrator manages the review of an RC definition (example changing the retention period or the lifecycle actions) and sends the new version of the RC definition for approval using the workflow described in Example 13.

### Example 25

The methods in Example 1 and Example 19, wherein the IGPM administrator may edit existing RC definitions, create new versions thereof, run these versions through the approval process, and eventually publish the new versions of these RC definitions:
The changes may impact lifecycle rules assigned to the Global jurisdiction or to any other jurisdiction
Through the integration of IGPM and IGCM, the new version of the RC becomes available in IGCM as soon as it is published in IGPM
The IGCM administrators responsible for the File Plans may choose to synchronize the definitions of the new RC versions with their corresponding RC definitions in the File Plan
The new RC version may be attributed an effective date in IGPM. This means that records associated with that RC and are catalogued in the File Plans in IGCM after this effective date will be governed according to the new and modified rule definitions

### Example 26

The methods in Example 1 and Example 19, wherein the IGPM administrator may close an RC in the Master Classification in IGPM.

If the IGCM administrator updates the corresponding RC definition in a File Plan he or she manages, the RC and the whole folder structure under that RC entry in the File Plan becomes closed:
Records already catalogued under that RC element are unaffected
No new records can be added to that branch of the File Plan tree

The following are a listing of terms and their related descriptions.

| Term | Description | Notes |
|---|---|---|
| BU | Business Unit within Entity | |
| CL | Corporate Language | |
| CTAM | Capture and Transparent Access Module | |
| DoD 5015.2 | RMS standard by US Department of | |
| | Defense | |
| ECM | Enterprise Content Management | |
| ESI | Electronically Stored Information | US Federal |
| | | Rules of Civil |
| | | Procedure |
| FRCP | US Federal Rules of Civil Procedure | |
| GPEL | Governance Policy Enforcement Layer | |
| IG | Information Governance | |
| IGCM | Information Governance Control Module | Marketing |
| | | Name: RSD |
| | | GLASS |
| | | Periscope |
| IGPM | Information Governance Policy Module | Marketing |
| | | Name: RSD |
| | | GLASS Mosaic |
| ISO | Reference model for open archival | OAIS |
| 14721:2003 | information system | |
| ISO 15489 | Best practices in RM | |
| JL | Jurisdiction Language | |
| MC | Master Classification | |
| MoReq2 & | Model Requirements for Electronic | European RM |
| 10 | Records Mgmt | standards |
| PII | Personally Identifiable Information | Data Privacy |
| RC | Record Class | |
| RC Group | Record Class Group | |
| RIM | Records and Information Management | Another |
| | | common term |
| | | for RM |
| RM | Records Management | Subset of IG |
| RMA | RM Application | |
| RMS | US NARA specifications for RM services | |
| RSD | RSD GLASS Governance Layer for | Trademark |
| GLASS ™ | Archival ServiceS | of RSD SA |
| TCS | Team Collaboration Site | Collaboration |
| | | tool such as |
| | | SharePoint |

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. An integrated computer-based system for managing records, comprising:
one or more microprocessors programmed to execute instructions of a policy module, the policy module,
(a) configured to receive a plurality of management inputs, each management input describing a requirement arising from legal, business and/or information technology considerations, the requirement describing how a governance function must be carried out with respect to a record class, and
(b) using the management inputs to produce a governance policy for the record class;
one or more microprocessors programmed to execute instructions of a control module, the control module,
(a) configured to receive a selection of one or more of the governance policies produced by the policy module, and
(b) configured to apply the selected governance policies to records created by a business division;
a record repository which stores the records of the business division and which is responsive to the control module's application of the selected governance policies by storing, imposing immutability on, imposing mutability on, or deleting the records according to the selected governance policies; and
a communications network connected to the microprocessors and the record repository, the network facilitating,
(a) receipt of the management inputs, and
(b) selection and application of governance policies.

2. The system of claim 1, wherein the legal consideration arises from more than one jurisdiction.

3. The system of claim 1, wherein each governance policy includes a description of the management inputs.

4. The system of claim 1, wherein each governance policy identifies jurisdictions for which the governance policy is applicable.

5. The system of claim 1, wherein each governance policy is associated with a class of records.

6. The system of claim 1, wherein at least one of the governance policies identifies a business event that triggers application of the governance policy.

7. The system of claim 6, wherein the control module is also configured to receive notification of the occurrence of the business event, and configured to recognize the notification as warranting triggering application of the governance policy.

8. The system of claim 1, wherein at least one of the governance policies identifies a duration after which the governance policy is applied.

9. The system of claim 1, wherein at least one of the governance policies identifies at least one action that is triggered after the occurrence of an event and the passing of a time period.

10. The system of claim 1, wherein icons corresponding to records of a business unit appear in a file plan, the file plan being a graphical representation of a hierarchical organization of icons corresponding to record classes, folders, sub-folders, and records, wherein the icons corresponding to the record classes in the file plan represent one or more of the record classes defined in the policy module, and wherein each record class corresponds to a unique type of record, wherein each type of record identifies a particular business function, and wherein the icons corresponding to the folders and sub-folders represent organizing units of records with common features.

11. The system of claim 10, wherein each of the file plans is associated with a jurisdiction and associated with a set of governance policies representing the governance policies applicable in that jurisdiction.

12. The system of claim 1, wherein the governance policy includes more than one requirement and at least one of the requirements has an application date that is different from the other requirements.

13. The system of claim 1, wherein application of the governance policy includes instructions to delete metadata associated with at least one of the records.

14. The system of claim 1, wherein application of the governance policy includes instructions to delete full-text indexes belonging to at least one of the records.

15. The system of claim 1, wherein application of the governance policy includes instructions to request confirmation from an administrator prior to acting on one of the records.

16. The system of claim 1, wherein application of the governance policy includes instructions to move one of the records from the record repository to another location.

17. The system of claim 16, wherein the another location is another record repository.

18. The system of claim 1, wherein more than one governance policy is selected for a particular one of the records, and the selected governance policies are applied independently of each other to the particular one of the records.

19. The system of claim 1, further comprising an editor module allowing for modification of a governance policy.

20. The system of claim 19, wherein the policy module produces a modified governance policy after the editor module is used.

21. The system of claim 20, wherein the control module applies the modified policies to records captured after an effective date of the modified policies.

22. A computer-based method for managing records, comprising:
providing one or more microprocessors programmed to execute instructions of a policy module, the policy module,
(a) configured to receive a plurality of management inputs, each management input describing a requirement arising from legal, business and/or information technology considerations, the requirement describing how a governance function must be carried out with respect to a record class, and
(b) using the management inputs to produce a governance policy for the record class;
providing one or more microprocessors programmed to execute instructions of a control module, the control module,
(a) configured to receive a selection of one or more of the governance policies produced by the policy module, and
(b) configured to apply the selected governance policies to records created by a business division;
providing a record repository which stores the records of the business division and which is responsive to the control module's application of the selected governance policies by storing, imposing immutability on, imposing mutability on, or deleting the records according to the selected governance policies; and
providing a communications network connected to the microprocessors and the record repository, the network facilitating,
(a) receipt of the management inputs, and
(b) selection and application of governance policies;
receiving management inputs;
producing the governance policy;
receiving a selection of one or more of the governance policies; and
applying the governance policies to the records.

23. The method of claim 22, wherein producing the governance policy includes adding a description of the management inputs.

24. The method of claim 22, wherein producing the governance policy includes identifying jurisdictions for which the governance policy is applicable.

25. The method of claim 22, further comprising associating each governance policy with a class of records.

26. The method of claim 22, wherein producing the governance policy includes identifying a business event that triggers application of the governance policy.

27. The method of claim 26, wherein the control module is also configured to receive notification of the occurrence of the business event, and configured to recognize the notification as warranting triggering application of the governance policy, and the step of applying the governance policies to the records occurs as a result of receiving the notification.

28. The method of claim 22, wherein at least one of the governance policies identifies a duration after which the governance policy is applied, and the step of applying the at least one governance policy occurs once the duration is achieved.

29. The method of claim 22, wherein at least one of the governance policies identifies at least one action that is triggered after the occurrence of an event and the passing of a time period, and the step of applying the at least one governance policy occurs once both the event occurs and the time has passed.

30. The method of claim 22, further comprising applying the governance policies to delete metadata associated with at least one of the records.

31. method of claim 22, wherein the step of applying the governance policies to the records includes instructions to delete full-text indexes belonging to at least one of the records.

32. The method of claim 22, wherein the step of applying the governance policies includes requesting confirmation from an administrator prior to acting on one of the records.

33. The method of claim 22, wherein the step of applying the governance policies includes moving one of the records from the record repository to another location.

34. The method of claim 22, wherein the another location is another record repository.

35. The method of claim 22, wherein the step of receiving the selection includes receiving selections for more than one governance policy for a particular one of the records, and the step of applying the selected governance policies is executed independently of each other to the particular one of the records.

36. The method of claim 22, further comprising providing an editor module, and using the editor module to modify at least one of the governance policies.

37. The method of claim 36, further comprising using the policy module to produce a modified governance policy after the editor module is used.

38. The method of claim 37, further comprising using the control module to apply the modified policies to records captured after an effective date of the modified policies.
